(19) United States
(12) Patent Application Publication
(10) Pub. No.: US 2011/0200233 A1
(43) Pub. Date: Aug. 18, 2011

(54) Biometric Sensing Using Scan Function of an All-in-One Printer Device

(76) Inventors: Keng Aik Boo, Singapore (SG); Wei Ming Pan, Singapore (SG)

(21) Appl. No.: 12/706,146

(22) Filed: Feb. 16, 2010

(51) Int. Cl. G06K 9/20; G06K 9/00

(52) U.S. Cl. 382/115; 382/312

(57) ABSTRACT

A low-cost method of biometric reading by using an optical scan portion of an All-In-One (AIO) type device. When generating the biometric reading, the users place a finger stationary while a scan bar of the AIO device sweeps across the placed finger to perform the scanning.

### BACKGROUND OF THE INVENTION

1. Field of the Invention

The present invention relates to information handling systems and more particularly to biometric sensing using a scan function of an all in one type device.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One example of an information handing system is a printing device such as an all in one (AIO) type printing device (also known as a multi function printer (MFP)). It is known to provide all in one type printing devices with a scan function.

### SUMMARY OF THE INVENTION

In accordance with the present invention, a low-cost method of biometric reading by using an optical scan portion of an All-In-One (AIO) type device is set forth. A benefit of the present invention over the low-cost off-the-shelf fingerprint readers is the ease of use. Such low-cost devices often require users to swipe their finger carefully and consistently, which may prove to be cumbersome and frustrating at times. In contrast, the present invention generally only needs users to place a finger stationary while a scan bar of the AIO device sweeps across the placed finger to perform the scanning.

More specifically, in one embodiment, the invention relates to a method for performing a biometric scan. The method includes providing an all in one device coupled to a host, the all in one device comprising an image sensor; performing a biometric scan of a user via the image sensor to provide a biometric image; and, generating biometric scan information based upon the biometric image.

In another embodiment, the invention relates to an apparatus for performing a biometric scan. The apparatus includes an all in one device coupled to a host, the all in one device comprising an image sensor; means for performing a biometric scan of a user via the image sensor to provide a biometric image; and, means for generating biometric scan information based upon the biometric image.

In another embodiment, the invention relates to an information handling system. The information handling system comprises an all in one device coupled to a host, the all in one device comprising an image sensor; a processor coupled to the all in one device; and memory coupled to the processor. The memory stores a system for performing a biometric scan. The system comprises instructions executable by the processor for: performing a biometric scan of a user via the image sensor to provide a biometric image; and, generating biometric scan information based upon the biometric image.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of an environment in which an all in one printer is used.

FIGS. 2A and 2B, generally referred to as FIG. 2, show a perspective view of an all in one printer having a biometric reader portion.

FIG. 3 shows a flow chart of the operation of a host only type biometric reader system.

FIG. 4 shows a flow chart of the operation of a shared host device type biometric reader system.

FIG. 5 shows a perspective view an alternate all in one printer having a biometric reader portion.

FIG. 6 shows a perspective view of another alternate all in one printer having a biometric reader portion.

### DETAILED DESCRIPTION

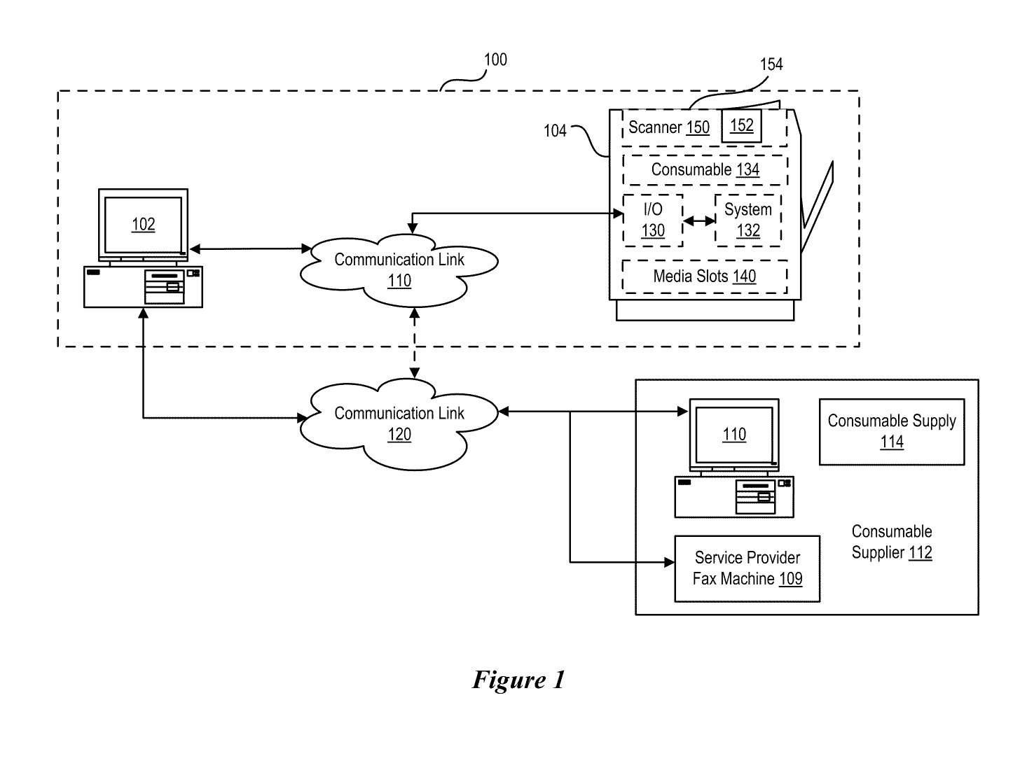

Referring to FIG. 1, a block diagram of an environment 100 in which an AIO device is used is shown. The environment includes a computer system 102 and an AIO device 104, coupled via a communication link 110. The communication link 110 might be a printer cable, a telephone cable, a network connection or any other link which information is communicated with the AIO device 104. In one embodiment, the AIO device 104 is included within a multifunction device such as a combination printer copy, scan fax machine. Also, in one embodiment, the environment does not include a computer system 102.

The AIO device 104 is coupled to a second communication link 120. Thus, communication may occur between the AIO device 104 and anything coupled to the second communication link 120 such as a services provider fax machine 109. Additionally, the computer system 102 is also connected to another computer system (e.g., a services provider computer system) 110 via a second communication link 120. The second communication link 120 may be a telephone system or some other type of network, such as the Internet. In one embodiment, the fax machine 109 and the computer system 110 are owned and operated by a fax machine service provider 112. In this example, the printer service provider 112 provides service for the AIO device 104.

The AIO device 104 includes an input output (I/O) port 130, a control system 132 and at least one of consumable 134. The I/O port 130 facilitates communications between the AIO device 104 and other devices connected to the communications link 110. The control system 132 provides the AIO device 104 with certain control functionality. The control system 132 includes a processor and memory coupled to the processor. The AIO device 104 may also include one or more media slots 140.

The consumables 134 represent any component in the AIO device 104 that is subject to depletion through use of the AIO device 104. For example, the consumable 134 may be a toner cartridge or an inkjet cartridge, etc. The AIO device service provider maintains a supply 114 of replacement consumables 134.

The AIO device 104 further includes a scanner portion 150. The scanner portion 150 includes an image sensor 152 (e.g., a scan bar) which traverses a flatbed scanner portion 154 (e.g., which often includes a clear platen). The scanner portion 150 optically scans objects (such as images, documents, etc.) that are placed on the flatbed scanner portion 154 via the image sensor 152 and converts the objects to a digital image.

In operation, the computer system 102 generates a document in an electronic form and transmits the document (in the form of a print job) to the device 104. The AIO device 104 receives the job via the I/O port 130 and prints the document. Additionally, the AIO device 104 may receive and print information from the communication link 120 or from a scanned image when operating as a scanner or copier. Additionally, the AIO device 104 may receive and print information from any of its media slots 140.

The environment 100 further includes a biometric reader system which may be implemented within the AIO device 104, the computer system 102 or some combination of the AIO device 104 and the computer system 102. The biometric reader system includes instructions stored on a computer readable memory which executed by a processor to perform certain functions.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

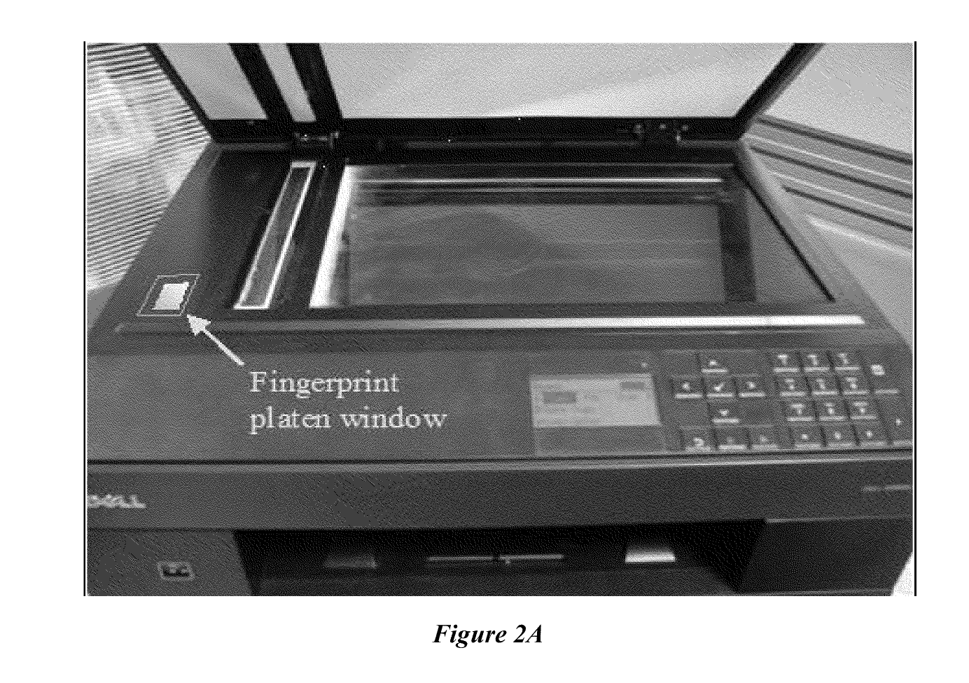

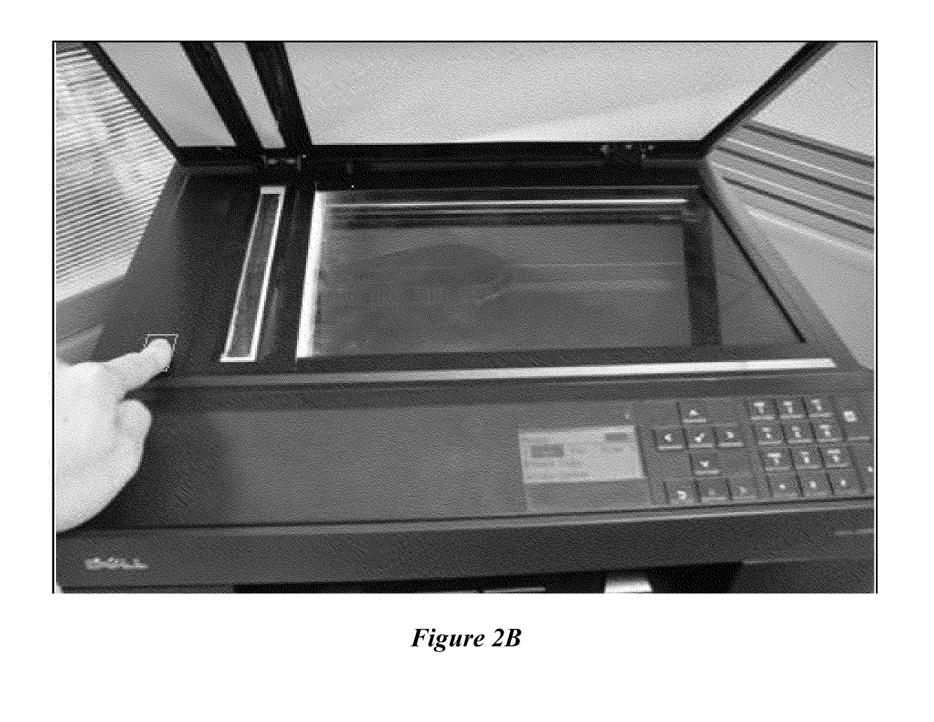

Referring to FIGS. 2A and 2B, generally referred to as FIG. 2, perspective views of an all in one printer having a biometric reader portion are shown. More specifically, the AIO device 104 includes a small platen window (i.e., a biometric reader window) which is implemented on a covered section of the flatbed scanner portion of the AIO device 104.

In operation, the image sensor 152 of the AIO device 104 moves to the window location when the scan lid is opened by the user. This is possible because the AIO device 104 includes a sensor that detects an opening action by the user. When a finger is placed on the platen window, the scanner detects this placement and proceeds to scan the fingerprint of the user.

In certain embodiments, the biometric reader system is implemented within the firmware of the AIO device 104. In this type of biometric reader system, the complete software/firmware solution is implemented in the AIO device 104 for ease of maintenance and support. Additionally, in this type of biometric reader system, host-device communication is not required during the authentication process. Also, in this type of biometric reader system, memory and computation resources within the AIO device 104 are enhanced for support the biometric reader system. Also, this type of biometric reader system does not require new Printer Job Language (PJL), Printer Model Language (PML), Printer Control Language (PCL) or Postscript (PS) commands to be created

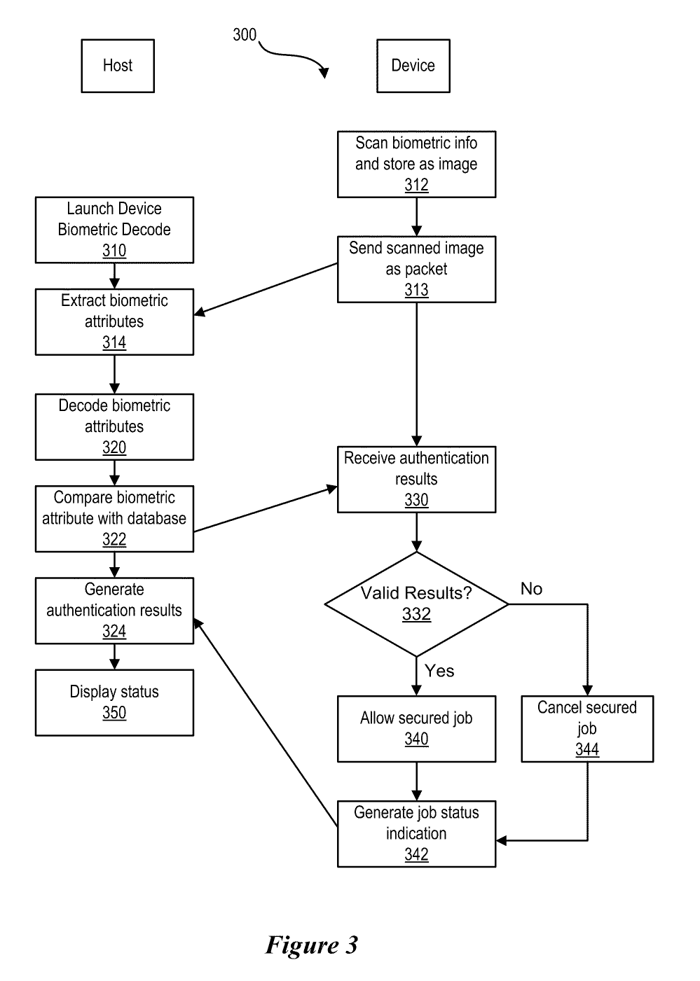

FIG. 3 shows a flow chart of the operation of a host only type biometric reader system 300. More specifically, in a host only type biometric reader system 300 the scanner function of the AIO device is used only as the image acquisition device and return the entire image for processing and authentication at a host (such as computer system 102). The biometric reader system 300 leverages a biometric device interface (such as the Microsoft Windows 7 operating system (Win7) Windows Biometric Device Interface (WBDI)) to complete the authentication process).

The host only type biometric reader system 300, leverages a BDI for ease of implementation at the host, stability of device driver in the operating system and access to a large database of biometric attributes data on the host. Such a system 300 allows very simple firmware implementation on the AIO device 104. Also, such a system can use very high communication transactions between the host and the AIO device during the authentication process. Such a system 300 involves a PJL command to describe a secured print state to initial decryption process for the print job and for the firmware to block the job until authentication is complete.

More specifically, with the host only type biometric reader system 300, the biometric reader system 300 is launched at step 310. The biometric reader system implements a WBDI and includes launching a decode agent on the host. Somewhat independent of the launching of the decode agent on the host, the device (e.g., AIO device 104) scans biometric information (e.g., a user fingerprint) and sends the scanned image at step 313. The host then extracts biometric attributes from the image at step 314. The extraction can include extracting, compressing, encrypting, and packaging of the attributes associated with the biometric image. The host then decodes the biometric attributes at step 320. The decoding can include decompressing the package, decoding the encrypted information (and possibly archiving) the biometric attributes.

Next at step 322, the host compares the biometric attributes with a database of attributes. This comparison may include using WBDI application program interface (API) calls. The host then generates authentication results and provides these results to the device at step 324. The device receives these results from the host at step 330 and analyzes these results at step 332 to determine if the results are valid. If the results are valid, then the device allows the secured job to proceed at step 340 and generates a job status indication at step 342. If the results are not valid then the secured job is canceled at step 344 and a job status indication is generated at step 342. The job status indication is provided to the host which then displays the status of the job at step 350.

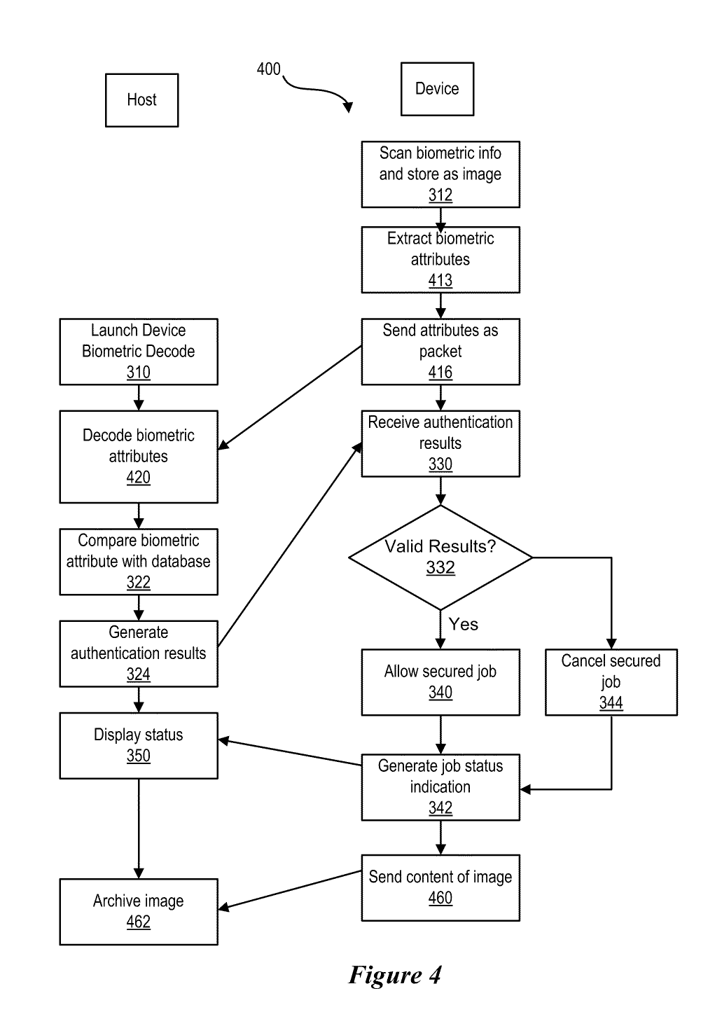

Referring to FIG. 4, a flow chart of the operation of a shared host device biometric reader system 400 is shown. In certain embodiments implementing a shared host device biometric reader system, the biometric reader system 300 leverages a biometric device interface (such as the Microsoft Windows 7 operating system (Win7) Windows Biometric Device Interface (WBDI)) to complete the authentication process). More specifically, the shared host device biometric reader system 400 acquires a biometric image (e.g., a print image such as a thumbprint) on the scanner portion of the AIO device 104, extracts biometric attribute information from the scanned biometric image at step 413, sends the biometric attribute as a packet to the host at step 416. The host processes this information using a BDI interface (such as the WBDI interface) at step 420 and sends the result of the processing to the AIO device 104. The system 400 leverages the BDI interface for ease of implementation at the host, stability of device driver in the operating system and access to a large database of biometric attributes data on the host. Such a system is also fairly simple and does not require special firmware to be implemented on the AIO device 104. However, such a system 400 involves a PJL command to describe a secured print state to initial decryption process for the print job and for the firmware of the AIO device 104 to block the job until authentication is complete. Also, such a system 400 involves a high communication transaction between the host and the AIO device 104 during the authentication process.

Thus the host only method disclosed with respect to FIG. 4 assumes that the host has the ability to derive biometric image attributes from a scanned image and proceed on with the processing of the image. Thereby resulting in a decision for the device. With the host only method, an entire scanned biometric image is provided from the device to the host. However, with the shared host device method disclosed with respect to FIG. 3, the device includes firmware capable of deriving biometric attributes from the scanned image. With the shared host device method, a relatively small packet (when compared to the image provided by the host only method) containing the extracted biometric attribute information is provided to the host by the device, thus minimizing network traffic between the host and the device.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

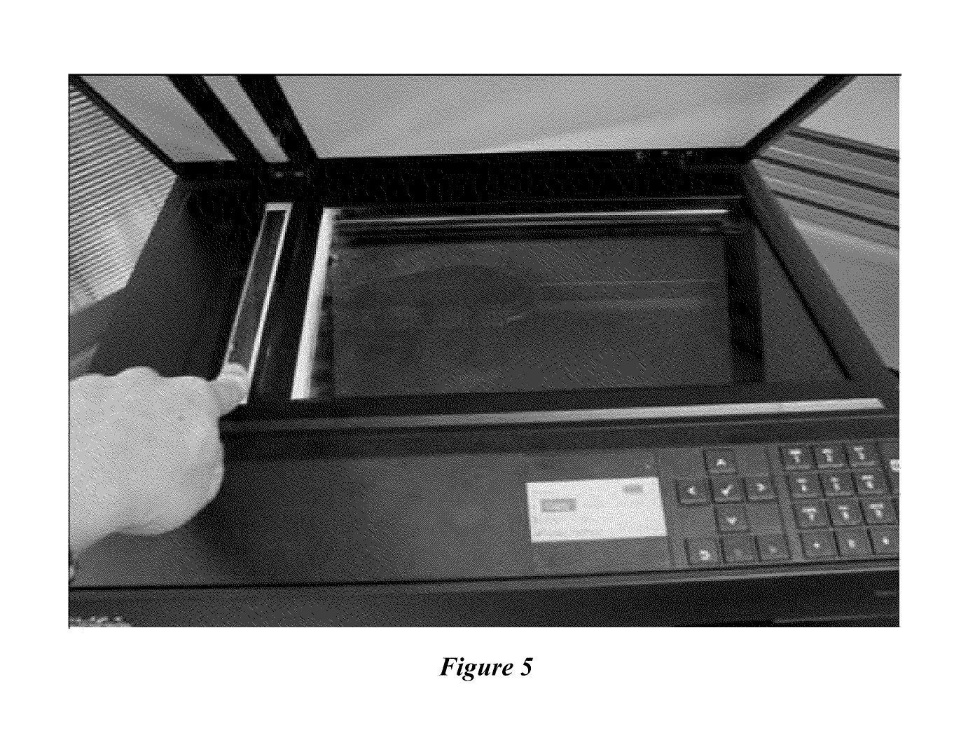

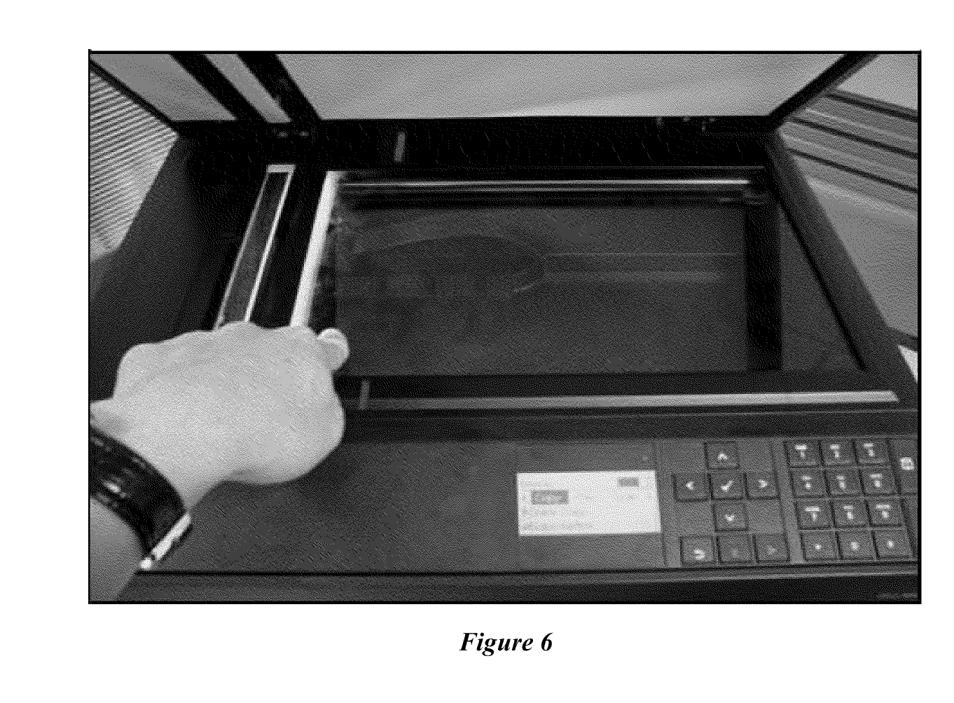

For example, FIGS. 5 and 6 shows perspective views alternate all in one devices having a biometric reader portion. These options utilize the Auto Document Feeder (FIG. 5) or Flatbed platen (FIG. 6). With the auto document feeder option, a portion of the automatic document feeder platen is dedicated as a biometric reader (when for example, the scan lid is opened). With the flatbed platen option, a portion of the flatbed is dedicated as a biometric reader (when for example, the scan lid is opened). With both of these options, the AIO device 104 may include indicia of where the biometric reader is located on either the automatic document feeder platen or the flatbed platen. Although these alternatives may be less expensive to implement, these alternatives may have limitations that make them less desirable. For example, these alternative devices may induce excessive glare coming from the uncovered section of the scan bar or could present a possibility of contamination of the platen glass which may affect the scan image quality.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably, or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for performing a biometric scan comprising:
providing an all in one device coupled to a host, the all in one device comprising an image sensor;
performing a biometric scan of a user via the image sensor to provide a biometric image; and,
generating biometric scan information based upon the biometric image.

2. The method for performing a biometric scan of claim 1 wherein:
the biometric scan information comprises fingerprint information.

3. The method for performing a biometric scan of claim 1 wherein:
the AIO device comprises a flatbed scanner portion, the flatbed scanner portion comprising a transparent platen window, the transparent platen window comprising a biometric scan portion; and further comprising
performing the biometric scan on the biometric scan portion of the transparent platen window.

4. The method for performing a biometric scan of claim 1 further comprising:
waking a scanner portion of the AIO device in response to opening of a lid of the AIO device; and
placing the AIO device in a biometric scan mode of operation upon waking the scanner portion of the AIO device.

5. The method for performing a biometric scan of claim 1 wherein the biometric scan further comprises:
performing a sweep of the optical sensor to capture a series of scan lines; and,
combining the series of scan lines to form the biometric image.

6. An apparatus for performing a biometric scan comprising:
an all in one device coupled to a host, the all in one device comprising an image sensor;
means for performing a biometric scan of a user via the image sensor to provide a biometric image; and,
means for generating biometric scan information based upon the biometric image.

7. The apparatus for performing a biometric scan of claim 6 wherein:
the biometric scan information comprises fingerprint information.

8. The apparatus for performing a biometric scan of claim 6 wherein:
the AIO device comprises a flatbed scanner portion, the flatbed scanner portion comprising a transparent platen window, the transparent platen window comprising a biometric scan portion; and further comprising
means for performing the biometric scan on the biometric scan portion of the transparent platen window.

9. The apparatus for performing a biometric scan of claim 6 further comprising:
means for waking a scanner portion of the AIO device in response to opening of a lid of the AIO device; and
means for placing the AIO device in a biometric scan mode of operation upon waking the scanner portion of the AIO device.

10. The apparatus for performing a biometric scan of claim 6 wherein the biometric scan further comprises:
means for performing a sweep of the optical sensor to capture a series of scan lines; and,
means for combining the series of scan lines to form the biometric image.

11. An information handling system comprising:
an all in one device coupled to a host, the all in one device comprising an image sensor;
a processor coupled to the all in one device;
memory coupled to the processor, the memory storing a system for performing a biometric scan, the system comprising instructions executable by the processor for:
performing a biometric scan of a user via the image sensor to provide a biometric image; and,
generating biometric scan information based upon the biometric image.

12. The information handling system of claim 11 wherein:
the biometric scan information comprises fingerprint information.

13. The information handling system of claim 11 wherein:
the all in one device comprises a flatbed scanner portion, the flatbed scanner portion comprising a transparent platen window, the transparent platen window comprising a biometric scan portion; and the system further comprising instructions for:
performing the biometric scan on the biometric scan portion of the transparent platen window.

14. The information handling system of claim 11 where in the system further comprises instructions for:
waking a scanner portion of the AIO device in response to opening of a lid of the AIO device; and
placing the AIO device in a biometric scan mode of operation upon waking the scanner portion of the AIO device.

15. The information handling system of claim 11 where in the system further comprises instructions for:
performing a sweep of the optical sensor to capture a series of scan lines; and,
combining the series of scan lines to form the biometric image.
